(19) United States
(12) Patent Application Publication
(10) Pub. No.: US 2012/0260743 A1
(43) Pub. Date: Oct. 18, 2012

(54) Assembly and Method for Measuring Pourable Products

(75) Inventors: Martin Hersche, Uzwil (CH); Urs Dübendorfer, Niederuzwil (CH); Martin Heine, Seuzach (CH)

(73) Assignee: Buhler AG, Uzwil (CH)

(21) Appl. No.: 13/516,515

(22) PCT Filed: Dec. 22, 2009
(86) PCT No.: PCT/EP09/67789

§ 371 Date: Jun. 15, 2012

(51) Int. Cl. G01F 1/78

(52) U.S. Cl. 73/861.351

(57) ABSTRACT

The invention relates to an assembly and method for cost-effective in-line NIR measurement, in particular for cost-effective in-line NIR measurement of ingredients, quality parameters or in general product characteristics of cereal grains, inter alia, and constituents thereof in product streams (3) in flour mills or animal feed mills or the like. Using at least one measuring probe (1), the reflection spectra are advantageously recorded on free-flowing product (3) in a flow tube and are transmitted to an evaluating device (2) disposed spatially separately therefrom and having an integrated spectrometer (12). The measured values determined by the evaluating device (2) are transmitted to a control unit (24) or to a management system (22), where they can be used for monitoring and/or regulating the processes or installations. In comparison to NIR systems used until now, the costs per measuring location can be greatly reduced by the simple product presentation and re-use of the evaluating device.

The invention relates to an arrangement and a method for the measurement of at least one characteristic of a product flow, in particular for the in-line NIR measurement of contents and quality parameters of pourable products, such as for example cereal grains and the constituent parts thereof, in product flows in flour or animal feed mills.

NIR measurements, that is to say measurements in the near-infrared range of the electromagnetic spectrum, of contents in cereal grains or constituent parts of cereal grains are known per se. EP-B-0539537 discloses an in-line method in which contents in the bulk material flow are determined, wherein the product is guided past a sensor element as a dense flow in a vertically aligned tube. The wavelength ranges of the reflected light are determined in a number of individual measurements for a spectrum.

For the arrangement described in said document, a dense, homogeneous bulk material flow is imperatively necessary in order to ensure adequate measurement accuracy. For this purpose, the product flow is backed up and is moved relative to the sensor element in the backed-up region. This is ensured by means of a discharge screw which serves to ensure a constant downward movement of the product in the measurement duct. Such a design is however structurally complex. Furthermore, the discharge screw must be operated with a very precise rotational speed in order to be able to realize a constant downward movement.

WO 85/04957 also describes an arrangement in which the product must be backed up, accumulated or compressed. The structural measures for this purpose are likewise highly complex. Furthermore, owing to the required periodic backing-up and onward conveyance of the product, said arrangement permits only a measurement in a bypass product flow.

It is the object of the invention to refine the known arrangement and method such that the disadvantages thereof are overcome. In particular, it is thus sought to provide an arrangement and a method for the measurement of a characteristic of a product flow, which arrangement and method permit easier guidance of the product flow past a measurement probe while simultaneously providing adequate measurement quality.

Said object and further objects are achieved by means of an arrangement according to the invention for the measurement of at least one characteristic of a product flow. The arrangement comprises at least one flow line in which the product flow can be guided. The flow line may be in the form of a flow pipe, in particular in the form of a circular-section or square-section pipe. Furthermore, the arrangement comprises at least one measurement probe which is designed and arranged such that at least one characteristic of the product flow guided in the flow line is measurable by means of the measurement probe.

The arrangement may be designed in particular for NIR measurement, in particular for in-line NIR measurement. Here, and below, the expression “in-line” (in particular in conjunction with an in-line measurement) is used as in “Prozessanalytik, Strategien and Fallbeispiele aus der industriellen Praxis” [“Process analytics, strategies and case studies from industrial practice”], published by Rudolf W. Kessler (2006). Accordingly, in the case of an in-line measurement, the measurement point at which the measurement probe is arranged is integrated into the product flow. An in-line measurement may thus be utilized to directly obtain information regarding the process and product characteristics. It is hereby possible in particular to eliminate the need for extracting samples.

According to the invention, at least in the region of the measurement probe, the flow line is inclined downward in a product flow direction by an angle of less than 75°, preferably at most 70°, more preferably at most 65°, particularly preferably at most 60° relative to the horizontal. Owing to the installed orientation of the flow line, therefore, the product flows with a downwardly directed vertical speed component. Here, the flow and in particular the product flow direction are predefined by the geometry of the flow line.

The product should flow in the form of as compact a curtain as possible past the measurement probe, in particular on a measurement window of the measurement probe. The measurement quality is influenced primarily by the bulk density, because the scatter of the light and therefore also the intensity of the reflected light change with the bulk density. The bulk density is determined inter alia by the angle of the flow line relative to the horizontal. In the case of a flow pipe with a cylindrical inner wall, in particular in the case of flow pipes in cereal or animal feed mills, the bulk density is furthermore determined by the product mass flow and the product speed, wherein the product speed in the case of freely running product is dependent on the inlet zone and on the angle.

Owing to the inclination according to the invention which deviates by more than 15° from the vertical, a homogeneous product flow is obtained at least at the lower inner wall of the flow line solely by virtue of the product sliding along said inner wall in a controlled manner. The product thus need not be backed up by complex measures, as is necessary in the prior art. The arrangement is hereby structurally significantly simpler and also considerably less susceptible to faults.

Depending on the requirements for measurement accuracy and depending on the respective product characteristics, the angle may also be varied within certain limits. For the measurement of flour, it has been found that, with shallow angles of around 50° relative to the horizontal, reliable measurement values are obtained already with a product mass flow of 50 kg/h or higher. The minimum angle is determined by the flowability of the product. For flours, the minimum angle lies in the region of 50° relative to the horizontal. If the pipe is mounted at a shallower angle, there is an increased risk of the product sticking and thus causing hygiene problems or product build-up. The cleaning of the measurement window by the incoming product can thus be ensured by a certain minimum inclination, such that self-cleaning occurs. Therefore, in particular for the measurement of flour, the flow line is preferably inclined downward by an angle of at least 50° relative to the horizontal at least in the region of the measurement probe.

By contrast, tests with flour have shown that, even with pipe angles of 75° relative to the horizontal, reliable measurement values can still be obtained if the mass flow is approximately>200 kg/h. It may however be necessary in some cases, in the case of mass flows in said range, for the inlet zone to be no larger than 2 m, because the product may otherwise already be distributed to too great an extent within the pipe, such that a homogenous layer no longer forms in front of the measurement window.

The measurement quality is crucially dependent on the fact that, depending on the product density, different thicknesses of product layer can be measured directly in front of the measurement window as a representative sample for the overall product flow. This is not a problem in the case of homogeneous products such as flour. However, if inhomogeneous products are to be measured, it must be ensured that this demand is still met.

In the prior art, measurement probes are known in which the measurement probe or parts thereof are arranged so as to be movable, such that cleaning can be carried out outside the product flow. Such arrangements are described for example in WO 2007/088047, WO 2007/009522 or EP 1837643. A movable arrangement is however structurally highly complex and is susceptible to failure. Said disadvantages are overcome by means of the self-cleaning action effected by the present invention.

In an advantageous embodiment, the cleaning of the measurement window is ensured substantially solely by the incoming product, such that self-cleaning takes place. In some embodiments, the cleaning may also be realized by means of additional components, such as for example compressed air, a mechanical wiper or high-frequency vibrations.

The measurement probe may, for the measurement by diffuse reflection, be configured with or without direct contact with the product or for transmission or transflection measurements.

As a measurement probe, use may be made in particular of a spectrometer measurement head as described in WO 2009/068022.

In preferred embodiments, the arrangement comprises backing-up means for generating a back pressure in the flow line, said backing-up means being arranged in the region of a measurement window of the measurement probe. With the aid of backing-up means of said type, the product flow can be backed up in the region of the measurement window, as a result of which, at least locally, a greater and therefore more representative and more homogeneous product quantity can be provided for the measurement. The backing-up means are particularly preferably formed so as to be static, that is to say immovable relative to the flow line. This permits a particularly simple and reliable design.

In preferred embodiments, an arrangement of the backing-up means in the region of the measurement window means that the backing-up means are arranged at a distance of at most 20 cm, preferably at most 10 cm, particularly preferably at most 5 cm from the measurement window. The backing-up means are particularly preferably arranged upstream of the measurement window.

It is however also conceivable for the backing-up means to be arranged downstream of the measurement window. The backed-up region can hereby likewise locally influence the product quantity in the measurement region of the measurement probe.

The backing-up means may be formed as a cross-sectional constriction of an inner wall of the flow line. This likewise constitutes a simple design.

The backing-up means may alternatively or additionally be formed as at least one baffle arranged in the flow line, in particular as a ramp.

It is possible for the backing-up means, in particular a baffle, in particular a ramp, to be formed at least partially by the measurement window itself. This likewise serves to provide a structurally simple design. If the product is diverted directly on the measurement window, the self-cleaning action is also improved.

The ramp and/or the measurement window are advantageously arranged at a shallower angle than the product flow direction. In this way, an improvement in product presentation is attained because the product is forced against the measurement window. Said additional pressure furthermore improves the self-cleaning action.

The preferred angle between the ramp and/or the measurement window and the product flow direction is dependent on the product characteristics and on the design of the flow line. For many applications, it has proven to be expedient for said angle between the measurement window and the product flow to lie in the range from 0° to 30°, preferably from 5° to 20°, particularly preferably from 8° to 15°.

It is conceivable for the measurement probe and in particular the measurement window to be arranged in the center of the flow line. This however leads to product accumulations in the region of the measurement window and of the holder of the measurement probe, such that these must be cleaned regularly. The above-cited patent applications WO 2007/088047, WO 2007/009522 or EP 1837643 duly provide corresponding structural measures for cleaning, but these are extremely complex.

The measurement window is therefore preferably arranged flush with the inner wall of the flow pipe. Dead spaces in which the product can accumulate and thereby possibly cause hygiene problems are thus eliminated.

The surfaces which delimit the interior of the flow line are highly advantageously substantially immovable at least in the region of a measurement window of the measurement probe. Said surfaces may be formed by or include the inner walls of the flow line. Aside from the inner walls of the flow line itself, the surfaces may however also encompass the surfaces of other components which protrude into the interior space, for example the surfaces of abovementioned baffles. For the purposes of the invention, it is specifically not essential that the product flow be supplied to the measurement probe by means of a forced movement. The omission of movable components reduces the susceptibility to failure and the maintenance outlay.

In some embodiments, the measurement probe may be arranged in a region of the flow line in which the product flow direction changes. Here, the product flow direction is defined by the design of the flow line and in particular by its shape of the inner walls. A local backing-up of the product in the region of the measurement probe can likewise be generated on the basis of such a change in the product flow direction, which in turn simplifies the measurement.

A change in the product flow direction may for example be attained in that, at least in the region of a measurement window of the measurement probe, an inner wall of the flow line is not rectilinear, in particular is curved and/or has a kink, as viewed in a certain sectional plane. Here, said sectional plane lies in such a way that it encompasses or is parallel to at least the local product flow direction.

The flow line may for example have a bend, wherein the measurement window is arranged in the region of said bend.

In advantageous embodiments, the measurement probe is arranged such that the product flow flows directly along a measurement window of the measurement probe. By means of this measure, air inclusions between the measurement window and the product flow, which could impair the measurement, can be eliminated.

For the regulation of processes, in particular for the regulation of processes in cereal and animal feed mills, information regarding simply the trend of the different measurement values is often sufficient to regulate the process or the plants. It has now been found that accuracy which is adequate for many applications can be attained with a significantly simplified product presentation. The flow line and the measurement probe are expediently designed and arranged such that at least one characteristic of a product flow which is feely flowing, in particular running or sliding in the flow line is measurable by means of the measurement probe. A freely flowing product flow flows under its own weight and need not be driven by a forced conveyance means, such as for example a discharge screw. The arrangement preferably has no means for forced conveyance of the product flow, such as for example a discharge screw, at the outflow side and at a distance of 20 cm, preferably 50 cm from the measurement probe.

Since it is the case when using the arrangement according to the invention that no backing-up of the product is necessary, the measurement can take place in a main product flow. Accordingly, the flow line and the measurement probe may be designed and arranged such that at least one characteristic in a main product flow is measurable by means of the measurement probe. It is thus not imperatively necessary for a bypass product flow to be branched off. It is self-evidently nevertheless possible, and likewise falls within the scope of the invention, for the flow line and the measurement probe to be designed and arranged such that at least one characteristic in a bypass product flow is measurable by means of the measurement probe.

To ensure reliable measurement, dirt accumulation on the measurement window should be prevented. Depending on the product, it may be advantageous for the cleaning action if the measurement window can be temperature-controlled. The temperature control may for example be effected by means of at least one heating wire or a heating coil in the direct vicinity of the measurement window. By means of the temperature control, it is for example possible to achieve a situation in which the temperature of the measurement window is higher than the temperature of the product, and thus no water condenses on the measurement window. Condensed water would specifically lead to dirt accumulation and possible measurement errors because the mixture of water and product can adhere to the measurement window, and cannot be removed, or can be removed only to an insufficient extent, by incoming product.

To evaluate the measurement data recorded by the measurement probe, the arrangement may comprise at least one evaluation unit. Here, the measurement probe and evaluation unit may be arranged in one housing. However, the arrangement preferably comprises a plurality of measurement probes, which may in particular be arranged at different locations in the product flow. For example, one measurement probe may also measure a characteristic of a product flow of a starting product, a further measurement probe may measure a characteristic of a product flow of an intermediate product, and yet a further measurement probe may measure a characteristic of a product flow of an end product. A measurement probe may optionally also be arranged in a laboratory area. Here, it is not imperatively necessary for all of the measurement probes of the arrangement to be arranged in a region of a suitable flow line; within the context of the invention, this must be the case merely for at least one measurement probe.

Through the use of cheap individual components, a highly simplified product presentation and an optional connection of a plurality of measurement probes, which may differ if required, to an evaluation unit, the costs per measurement location can be considerably reduced in relation to previously used NIR measurement systems.

The evaluation unit may be connected or connectable to the one or more measurement probes by at least one fiber optic cable. Via said fiber optic cable, the light reflected by the product at the respective measurement locations can be transmitted from the measurement probes to the evaluation unit. The fiber optic cable may in particular be designed for transmitting light energy in the NIR range (780-2500 nm). The use of fiber optic cables also permits the arrangement of the evaluation unit spatially separate from the one or more measurement probes.

The arrangement may likewise comprise at least one control cable by means of which the evaluation unit is connected or connectable to the one or more measurement probes.

The evaluation unit may furthermore comprise at least one spectrometer which breaks down the light transmitted for example via a fiber optic cable and measures the intensities. The spectrometer may for example be a diode array spectrometer such as is known per se. It is conceivable here for different measurement probes to be assigned different spectrometers.

Furthermore, the evaluation unit may also comprise further components such as for example further optical elements, an embedded PC with control and operating software, the necessary electronics, and/or, if a plurality of measurement probes is provided, an optical multiplexer such as is known per se.

With said combination of spectrometer and multiplexer, it is generally possible to perform only a sequential measurement of the different measurement locations, that is to say the measurement probes are interrogated in succession. An arrangement which permits parallel interrogation of the individual probes is hitherto not known within a budget normally demanded in the industry. This can however be realized for example through the use of a “Pushbroom Imager”, such as is known per se, as a multiple spectrometer. A “Pushbroom Imager” of said type samples the image area with a two-dimensional detector array, wherein at the same time the spectral information of each point of a line is recorded. For further details regarding the “Pushbroom Imager”, reference is made to chapters 9.4.1 and 9.6.2.3 in “Prozessanalytik, Strategien and Fallbeispiele aus der industriellen Praxis” [“Process analytics, strategies and case studies from industrial practice”], published by Rudolf W. Kessler (2006).

From the spectra recorded by the spectrometer, it is possible within the evaluation unit for the corresponding contents (quantitative and/or qualitative), quality parameters and/or further product characteristics to be determined and output as measurement values. The calibration of the corresponding contents, quality parameters and/or product characteristics may advantageously be performed using commercially available software which provides chemometric tools and which can work with multivariate data sets. The result of said calibration work is models which are loaded onto the evaluation unit. The operating software of the NIR system permits the assignment of different models of said type to the individual measurement locations.

The evaluation unit and/or the operating software of the evaluation unit may be designed to filter out unsuitable spectra in order that said spectra are not used for the determination of measurement values. Such unsuitable spectra may for example arise if the measurement window is not covered to a sufficient extent by product at all times or if the bulk density is so low that too little diffusely reflected light for the evaluation falls on the measurement probe. Spectra from these states should preferably not be evaluated because they would deliver a false result. Said states can be identified for example by a relatively high base line in the spectrum. It is possible for unsuitable spectra to be identified automatically through suitable selection of product-dependent threshold ranges and values. Alternatively, the spectra may also be evaluated and filtered on the basis of further mathematical characteristic values which can be calculated using chemometric software tools such as are common nowadays.

To establish a model, use is usually made of a reference database which contains spectra and associated reference values (for example contents or quality parameters). The reference database advantageously covers the entire range to be measured. For measurements in the process, consideration should also be given here in particular to different product temperatures and, in contrast to the prior art, also different product densities. In this way, the variations in product temperature and density during operation can be suitably compensated, and interpretation errors can be eliminated.

The arrangement may furthermore comprise a control unit and/or a management system. The measurement values can be transmitted to these. The control unit or the management system can then perform the regulation of a superordinate process and/or of a superordinate plant. The superordinate process may for example be a milling process in which a product flow is processed, and the superordinate plant may be the milling plant used for this purpose.

The present invention also relates to a method for the measurement of at least one characteristic of a product flow. Said method may in particular be a method for NIR measurement, and especially a method for in-line NIR measurement. The method may be carried out by means of a device according to the invention. In the method, at least one characteristic of a product flow which is guided in a flow line, in particular in a flow pipe, is measured by means of a measurement probe. According to the invention, at least in the region of the measurement probe, the flow line is inclined downward in a product flow direction by an angle of less than 75°, preferably at most 70°, more preferably at most 65°, particularly preferably at most 60° relative to the horizontal. The implementation of the method yields the advantages which have already been described in conjunction with the device according to the invention.

It is preferable for spectra in the NIR range to be recorded by means of at least one measurement probe.

It is likewise preferable for the product flow to flow directly along a measurement window of a measurement probe. In this way, air inclusions between the measurement window and the product flow, which could impair the measurement, can be eliminated.

It is furthermore preferable for the measurement to be performed on a freely flowing product flow. A cumbersome backing-up of the product is thus not necessary.

The measurement is preferably performed on a main product flow. It is however also conceivable, and falls within the scope of the invention, for the measurement to be performed on a bypass product flow.

In some embodiments, measurement data, in particular spectra in the NIR range, recorded by the measurement probe are transmitted to an evaluation unit arranged in particular spatially separate from said measurement probe. The evaluation unit is advantageously situated at a protected location with as constant a room temperature as possible, such as for example in a measurement control room or in a measurement cabinet. In this way, any possible temperature-dependent drift in the recording of the spectra by the spectrometer of the evaluation unit can be eliminated. Alternatively, the housing of the evaluation unit may be equipped with a temperature regulation means. Furthermore, as a result of the arrangement of the evaluation unit outside the process region, other electronic components (such as for example an embedded PC) are also not exposed to the adverse process conditions (such as for example intensely varying temperatures or vibrations).

It is furthermore possible for the measurement data recorded by the measurement probe, in particular the measurement values calculated by means of the model and/or the spectra in the NIR range, to be transmitted to a management system and/or a control unit and are processed there.

In the implementation of the method, at least two measurement probes can be interrogated in succession.

In the method, the product flow may contain or be composed of cereal grains and/or the constituents thereof.

The method can be used to measure for example contents and/or quality parameters of the product flow, such as for example the starch damage.

The product flow may contain starting products, intermediate products and/or end products of a production process, for example of a crushing process, for example of a milling process.

The measurement is preferably carried out in-line.

In a mill, it is often the case that different recipes for the processing of different cereal types or for the production of different flour types or flour mixtures are processed on the same plant. It is thus possible, for example, for a measurement probe to be arranged at a measurement location at which, for example, in the case of one recipe, it measures bread flour, and in the case of another recipe, it measures biscuit flour. In possible embodiments, it is thus provided that the measurement probes are or can be assigned different calibration models. Here, it is possible in particular for the assignment to take place automatically in conjunction with the selected recipe, and/or the arrangement may perform the assignment itself by means of classification. In this way, it is possible, in the case of two different flours, for different models to be used, or in the case of one flour, for additional parameters to be measured. The respective models may be assigned to the recipes and then automatically used by the system. It would furthermore also be conceivable for the measurement system to automatically detect which product is being guided past the measurement probe and then automatically select the relevant model.

Finally, a further aspect of the invention relates to the use of an arrangement according to the invention. The arrangement according to the invention and the method according to the invention permit for example the measurement of contents and quality parameters or general product characteristics of pourable products during product preparation and processing for the purpose of process monitoring (measurement) and control and/or regulation of the plants and/or processes.

The invention relates in particular to the use of an arrangement according to the invention in
in particular complete plants in the cereal milling industry;
plants for flour preparation for industrial bakeries;
plants in the special milling industry in particular for the shelling and/or grinding of soya, buckwheat, barley, oats, spelt, millet/sorghum, pseudo-cereals and/or pulses;
plants for the production of feed for production animals and pets;
special plants for the production of feed for fish and crustaceans;
premix and concentrate plants for the production of active substance mixtures;
plants for recovering oil from oilseed; plants for the treatment of extraction meal and white flakes;
plants for the processing of biomass and the production of energy pellets;
plants for ethanol production;
in particular complete rice processing plants; sorting plants for foodstuffs, seeds and plastics;
plants for cereal and soya handling;
plants for the unloading and/or loading of ships, heavy goods vehicles and trains from storage to discharge of cereals, oilseed and derivatives;
silo facilities for vertical steel and concrete silos, and flat stores;
mechanical and pneumatic ship unloaders and ship loaders;
industrial malting and malt handling plants; machines and plants for the processing of cocoa beans, nuts and coffee beans;
machines and plants for the production of chocolate and filling and coating compounds;
machines and plants for the molding of chocolate articles;
plants for the production of pastas, in particular long goods, short goods, nidi, lasagne, couscous and specialty pastas;
systems and plants for the extrusion (cooking and forming) of breakfast cereals, food and feed ingredients, pet food, aqua feed and pharmaceutical products;
plants for the production of paints, lacquers and dispersions;
machines and process facilities for the production of printing inks, coatings and particle dispersions for the cosmetics, electronics and chemical industries;
plants for the heat treatment of polymers (PET);
plants for the production of PET for bottles;
SSP and conditioning plants for the treatment of PET and other plastics;
plants for bottle-to-bottle recycling;
plants for the production of ready-made nanoparticle dispersions;
plants for the isolation and characterization of aleuron from brans, in particular wheat brans;
plants for rice fortification.

A wide variety of measurement tasks can be performed by means of the arrangement according to the invention and the method according to the invention in particular for in-line NIR measurement. In the cereal milling industry, it is desirable to determine in particular the following measurement variables:
for whole grain measurement:
   water content;
   protein content;
   ash content (mineral substances);
for the measurement of flours or flour intermediate products:
   water content;
   protein content;
   ash content (mineral substances);
   starch damage;
for the measurement of by-products:
   water content;
   residual starch content.

These measurement variables can be determined by means of the device according to the invention and the method according to the invention. The measured product characteristics can provide the plant operator with valuable information regarding the running of the process and may be used in a variety of ways in a further step for plant or process regulation. It is possible, for example, for regulating loops to be established for networks or recipes. The composition of mixtures can likewise be analyzed and optionally readjusted.

The arrangement preferred for the in-line NIR measurement is of modular construction and comprises basically at least one measurement probe and at least one evaluation unit. To keep the costs per measurement location as low as possible, a plurality of measurement probes should be connected to one evaluation unit. In an advantageous embodiment, the evaluation unit is arranged spatially separate from the measurement probes in order to attain greater independence from the often adverse process environment conditions.

A plurality of measurement probes (in situ probes with lighting unit, optics and electronics) may be arranged in a plant as follows:
for the measurement of starting/unprocessed products;
for the measurement of intermediate products;
for the measurement of end products;
for the measurement of individual samples in the laboratory area under defined conditions.

The defined conditions include for example a defined temperature and/or a defined air humidity, which can in particular be held constant.

In an advantageous embodiment, the measurement probes are designed such that they can be integrated into different environments, machines or plants and are composed of in particular cheap individual parts. It is also expedient for the measurement probes to permit continuous measurement operation.

The invention will be explained in more detail below on the basis of exemplary embodiments and the drawing, in which:

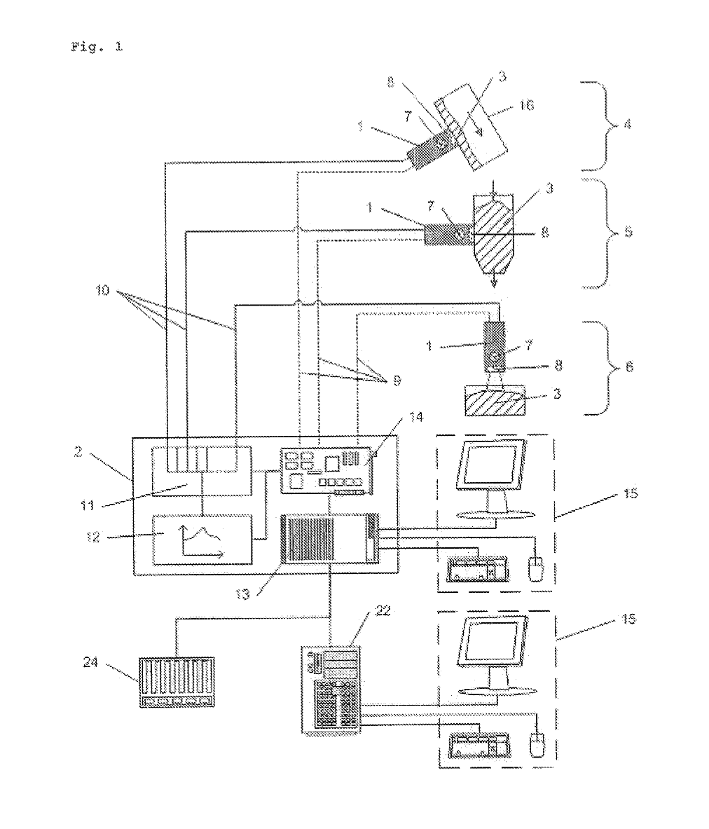

FIG. 1 shows a schematic illustration of an arrangement according to the invention for in-line NIR measurement in a main flow, in a backed-up zone of a bypass flow and in a laboratory area;

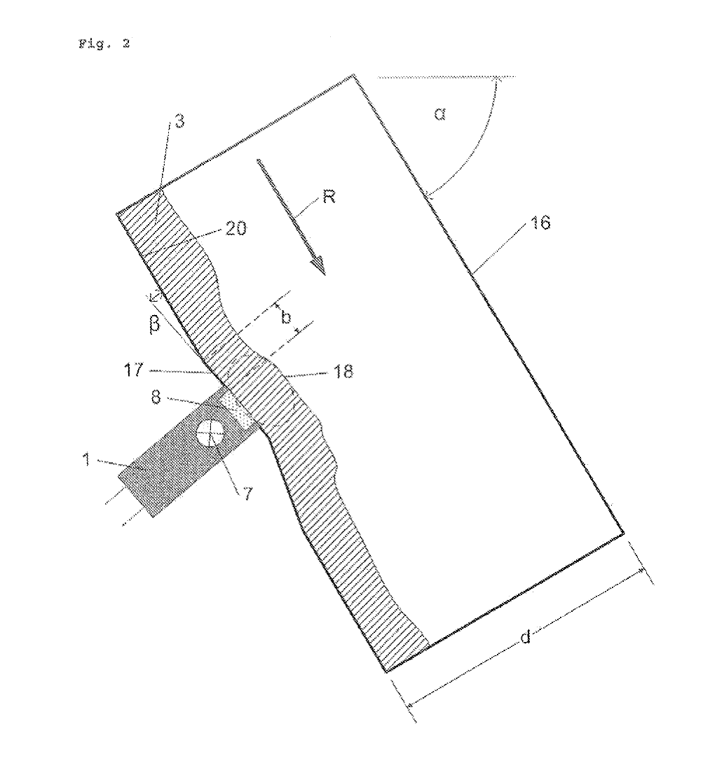

FIG. 2 shows a detail of the arrangement as per FIG. 1 with a measurement probe arranged in the region of a ramp;

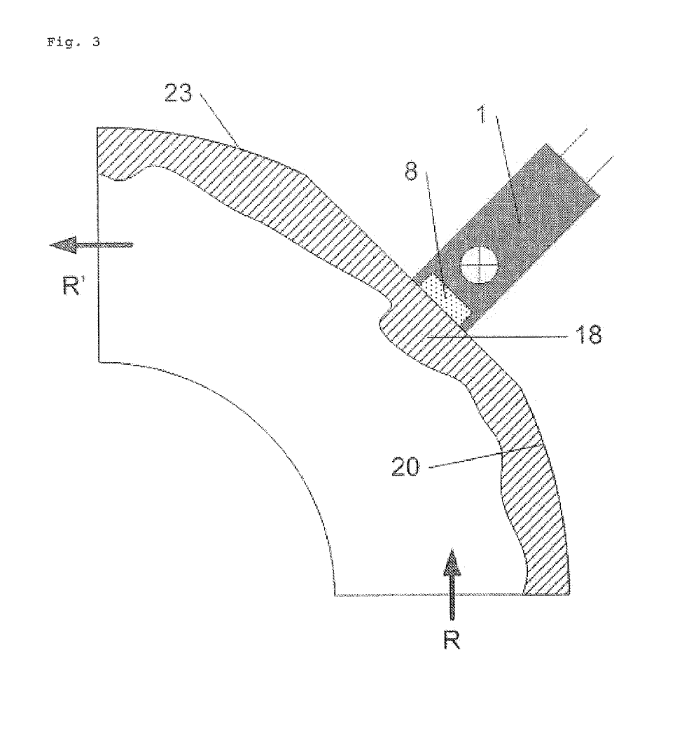

FIG. 3 shows a further arrangement according to the invention for measurement in a curved pneumatic pipe.

As per the illustration, the arrangement is composed substantially of at least one measurement probe 1, in an advantageous embodiment a plurality of measurement probes 1, and an evaluation unit 2. Here, the construction and mode of operation of the measurement probes 1 should be adapted to the product 3 to be measured and to the ambient conditions. For example, for powdery products 3 such as for example flour, it has proven to be expedient to perform the measurement by diffuse reflection. Here, the product 3 may be measured through contact, either by means of the method according to the invention in a flow line in the form of a downward-sloping pipe 16 within a downward-sloping zone 4, or, as has hitherto been conventional, in a backing-up zone 5. Furthermore, measurement may also be carried out by diffuse reflection contactlessly, that is to say with a spacing between the measurement window and the product 3 to be measured. Said arrangement may be advantageous for other purposes, for example in the case of measurements in a laboratory area 6 or over conveyor belts or the like. Further measurement processes not illustrated in FIG. 1, such as for example the abovementioned measurement over a conveyer belt without direct product contact or the measurement of low-absorbance media by transmission or transflection, may be integrated with measurement probes designed for this purpose in any desired combination into the present arrangement and connected to the evaluation unit 2. Furthermore, for all of the measurement processes, it is advantageous for the product 3 to be moved continuously during the measurement, because in this way a greater product volume can be measured.

In an advantageous embodiment, the measurement probes 1 comprise in each case at least one light source 7 by means of which the product 3 to be measured is illuminated in the spectral range of interest through a measurement window 8 which has low-absorbance properties in the respective spectral range. For measurements in the near-infrared (NIR) range, sapphire glass has proven to be expedient as a measurement window material in the process environment. For process reliability, the light source 7 may be of redundant configuration.

For control and for the supply of energy, the measurement probes 1 are connected by means of control cables 9 to the evaluation unit 2. Said control cabling may, as in FIG. 1, be realized by means of a star structure; a tree structure is however also possible. The measurement probes 1 are additionally connected via fiber optic cables 10 to the evaluation unit 2. The light which is reflected diffusely by the product 3 is transported by said fiber optic cables 10 from the measurement probes 1 to the evaluation unit 2. An optical multiplexer 11 is integrated in the evaluation unit 2 for operation with a plurality of measurement probes 1. Said optical multiplexer 11 permits the sequential transmission of the light transported by the fiber optics 10. The number of channels is dependent on the type of multiplexer 11 and may be selected as desired. By means of the multiplexer 11, the signal from a measurement probe 1 is transmitted to the spectrometer 12, which records the light intensity as a function of the wavelength. The diode array has proven to be a suitable spectrometer for use in cereal and feed mills. The recorded spectra are evaluated on an embedded PC 13. Also integrated in the evaluation unit 2 are the electronics 14 required for operation. The operation of the evaluation unit 2 and the visualization of the measurement values may be realized directly in the embedded PC 13 or by means of a management system 22 with corresponding operating and visualization elements 15. If the measurement values are provided to the management system 22 or to a control unit 24 such as for example a PLC (programmable logic controller), said measurement values can be used relatively easily for control and regulation tasks within the processes and/or plants.

FIG. 2 shows the actual measurement arrangement for the measurement of pourable products 3 in a flow line in the form of a downward-sloping pipe 16. In the cereal and feed milling industry, the downward-sloping pipe 16 normally has a diameter d of 120 mm or 150 mm. Here, the product 3 to be measured flows freely, that is to say solely under the force of gravity, in the downward-sloping pipe 16 and directly past a measurement window 8 of the measurement probe 1. The downward-sloping pipe 16 is for this purpose inclined downward in the product flow direction R at an angle a relative to the horizontal. The angle a may vary depending on the product 3 and installation situation. Angles α a of 50° to 75° have proven to be expedient for the angle α for the measurement of flour. The measurement probe 1 with measurement window 8 is designed and arranged such that the product flow 3 is measurable by means of the measurement probe 1. That part of the measurement probe 1 which is in contact with the product has a diameter of 19 mm. The measurement window 8 has a diameter of 13 mm.

For adequate measurement quality, the product layer 18 directly in front of the measurement window 8 must have a certain minimum bulk density which is dependent on the intensity with which the product 3 diffusely reflects the infrared radiation. To increase the bulk density in front of the measurement window 8, the downward-sloping pipe 16 is shaped such that the measurement window 8 is mounted at an angle β relative to the product flow 3. The measurement window 8 thus forms a part of a ramp 17 which forms a backing-up means for generating a back pressure. It must be ensured here that no cavities are formed which could lead to product accumulations and therefore hygiene problems. The ramp 17 extends upstream from the measurement window 8 over a distance b of at most 5 cm. The smaller said distance is selected to be, the more pronounced is the self-cleaning action exerted on the measurement window 8 by the incoming product. The ramp 17 is immovable relative to the downward-sloping pipe 16 and simultaneously forms a cross-sectional constriction of the inner wall 20 of the downward-sloping pipe 16.

The angle β is dependent on the product characteristics and on the design of the downward-sloping pipe 16. For the measurement of flour, it has been found that good results are obtained with an angle β of 10°. The product flow 3 is diverted directly in front of the measurement window 8, which likewise leads to an increased contact pressure on the measurement window 8. This fact is advantageous in that the cleaning effect imparted to the measurement window by the incoming product 3 is improved.

FIG. 3 shows a further embodiment. Here, the flow line is in the form of a pneumatic line 23. The measurement probe 1 and the measurement window 8 are arranged in a region of the pneumatic line 23 in which an incoming product delivery direction R is changed, owing to the shape of the inner wall 20 of the pneumatic line 23, into an outgoing product delivery direction R′, specifically in the region of a pipe bend. The inner wall 20 is thus not rectilinear in a region of the measurement window 8 but rather has a kink in the drawing plane which encompasses the incoming product flow direction R and the outgoing product flow direction R′. The product is hereby forced against the measurement window 8 owing to centrifugal forces. This also increases the self-cleaning action on the measurement window 8.

The pneumatic line 23 is flattened in the region of the planar measurement window 8, and furthermore forms a baffle, which leads to an additional back pressure.

1-36. (canceled)

37. An arrangement for the measurement of at least one characteristic of a product flow, comprising
at least one flow line in which the product flow can be guided,
at least one measurement probe which is designed and arranged such that at least one characteristic of the product flow guided in the flow line is measurable by means of the measurement probe,
wherein at least in the region of the measurement probe, the flow line is inclined downward in a product flow direction by an angle of less than 75° relative to the horizontal.

38. The arrangement as claimed in claim 37, comprising backing-up means for generating a back pressure in the flow line, said backing-up means being arranged in the region of a measurement window of the measurement probe.

39. The arrangement as claimed in claim 38, wherein the backing-up means are formed as a cross-sectional constriction of an inner wall of the flow line.

40. The arrangement as claimed in claim 38, wherein the backing-up means are formed as at least one baffle arranged in the flow line.

41. The arrangement as claimed in claim 38, wherein the backing-up means are formed at least partially by the measurement window.

42. The arrangement as claimed in claim 37, wherein at least in the region of a measurement window of the measurement probe, an inner wall of the flow line is not rectilinear, as viewed in a sectional plane, wherein the sectional plane encompasses or is parallel to the local product flow direction.

43. The arrangement as claimed in claim 37, wherein a measurement window of the measurement probe can be temperature-controlled.

44. An arrangement for the measurement of at least one characteristic of a product flow, wherein the arrangement comprises:
at least one flow line in which the product flow can be guided,
at least one measurement probe which is designed and arranged such that at least one characteristic of the product flow guided in the flow line is measurable by means of the measurement probe,
wherein the measurement probe of the measurement probe is arranged in a region of the flow line in which the product flow direction defined by the flow line changes.

45. The arrangement as claimed in claim 44, wherein at least in the region of a measurement window of the measurement probe, an inner wall of the flow line is not rectilinear, as viewed in a sectional plane, wherein the sectional plane encompasses or is parallel to the local product flow direction.

46. The arrangement as claimed in claim 44, wherein a measurement window of the measurement probe can be temperature-controlled.

47. A method for the measurement of at least one characteristic of a product flow, wherein at least one characteristic of a product flow which is guided in a flow line is measured by means of a measurement probe, wherein at least in the region of the measurement probe, the flow line is inclined downward in a product flow direction by an angle of less than 75° relative to the horizontal.

48. The method as claimed in claim 47, wherein spectra in the NIR range are recorded by means of at least one measurement probe.

49. The method as claimed in claim 47, wherein the measurement is performed on a freely flowing product flow.

50. The method as claimed claim 47, wherein use is made of at least two measurement probes which are interrogated in succession.

51. The method as claimed in claim 47, wherein the product flow contains or is composed of particles selected from the group consisting of cereal grains and the constituents thereof.

52. The method as claimed in claim 47, wherein the measurement probes are or can be assigned different calibration models.
